(19) United States
(12) Patent Application Publication
(10) Pub. No.: US 2026/0308321 A1
(43) Pub. Date: Oct. 8, 2026

(54) MEDIUM MOLECULAR WEIGHT POLY(PHENYLENE ETHER) AND METHOD FOR THE MANUFACTURE THEREOF

(71) Applicant: SHPP GLOBAL TECHNOLOGIES B.V., Bergen op Zoom (NL)

(72) Inventors: Huseyin TAS, Delmar, NY (US); Alvaro CARRILLO, Delmar, NY (US)

(21) Appl. No.: 19/482,994

(22) PCT Filed: May 13, 2024
(86) PCT No.: PCT/IB2024/054647

§ 371 Date: Nov. 10, 2025

Related U.S. Application Data
(60) Provisional application No. 63/466,453, filed on May 15, 2023.

(51) Int. Cl. C08G 65/44

(52) U.S. Cl. CPC C08G 65/44

(57) ABSTRACT

A poly(2,6-dimethyl-1,4-phenylene ether) can be prepared by a method that includes reacting 2,6-dimethylphenol in the presence of a solvent, oxygen, copper ion, a counter ion, and N,N′-di-tert-butylethylenediamine to form the poly(2,6-di-methyl-1,4-phenylene ether). The N,N′-di-tertbutylethylenediamine is present in an amount of 0.47 to 0.6 weight percent based on the weight of 2,6-dimethylphenol, and the copper ion is present in a molar ratio of 2,6-dimethylphenol to copper ion of 900:1 to 1300:1. The process provides poly(2,6-dimethyl-1,4-phenylene ether) having an intermediate molecular weight and intrinsic viscosity.

### CROSS REFERENCE TO RELATED APPLICATION

This application claims priority to U.S. Provisional Patent Application No. 63/466,453, filed on May 15, 2023, the contents of which are hereby incorporated by reference in their entirety.

### BACKGROUND

Poly(phenylene ether) s are a class of thermoplastics known for excellent water resistance, dimensional stability, and inherent flame retardancy, as well as outstanding dielectric properties over a wide frequency and temperature range. Properties such as strength, stiffness, chemical resistance and heat resistance can be tailored by blending poly(phenylene ether) s with various other plastics in order to meet requirements of a wide variety of consumer products, for example, fluid engineering parts, electrical enclosures, automotive parts, and insulation for wire and cable.

There remains a need in the art for poly(phenylene ether) s having an intermediate molecular weight (i.e., in the range of 10,000 to 40,000 grams per mole). Such intermediate molecular weight poly(phenylene ether) s can provide unique solution and melt properties, thus enabling enhanced processability not achievable with conventional higher or lower molecular weight poly(phenylene ether) s.

### SUMMARY

According to an aspect of the present disclosure, a medium molecular weight poly(2,6-dimethyl-1,4-phenylene ether) has a weight average molecular weight of 10,000 to 40,000 grams per mole, determined using gel permeation chromatography and an intrinsic viscosity of 0.13 to 0.3 deciliters per gram, as determined by Ubbelohde viscometer at 25° C. in chloroform, wherein the medium molecular weight polyphenylene ether is made by method comprising: reacting 2,6-dimethylphenol in the presence of a solvent, oxygen, copper ion, a counter ion, and N,N′-di-tertbutylethylenediamine to form the medium molecular weight poly(2,6-dimethyl-1,4-phenylene ether); wherein N,N′-di-tertbutylethylenediamine is present in an amount of 0.47 to 0.6 weight percent based on the weight of 2,6-dimethylphenol; and wherein the copper ion is present in a molar ratio of 2,6-dimethylphenol to copper ion of 900:1 to 1300:1.

Another aspect is a method for the manufacture of a medium molecular weight poly(2,6-dimethyl-1,4-phenylene ether), the method comprising: reacting 2,6-dimethylphenol in the presence of a solvent, oxygen, copper ion, a counter ion, and N,N′-di-tertbutylethylenediamine to form the poly(2,6-dimethyl-1,4-phenylene ether); wherein N,N′-di-tertbutyletbylenediamine is present in an amount of 0.47 to 0.6 weight percent based on the weight of 2,6-dimethylphenol; wherein the copper ion is present in a molar ratio of 2,6-dimethylphenol to copper ion of 900:1 to 1300:1; wherein the poly(2,6-dimethyl-1,4-phenylene ether) has a weight average molecular weight of 10,000 to 40,000 grams per mole, determined using gel permeation chromatography; and wherein the poly(2,6-dimethyl-1,4-phenylene ether) has an intrinsic viscosity of 0.13 to 0.3 deciliters per gram, as determined by Ubbelohde viscometer at 25° C. in chloroform.

Another aspect is a thermoplastic composition comprising the medium molecular weight poly(2,6-dimethyl-1,4-phenylene ether).

Another aspect is an article comprising the medium molecular weight poly(2,6-dimethyl-1,4-phenylene ether) or the thermoplastic composition comprising the medium molecular weight poly(2,6-dimethyl-1,4-phenylene ether).

The above described and other features are exemplified by the following detailed description.

### DETAILED DESCRIPTION

In oxidative polymerization of phenols, there are two competing mechanisms: (1) polymer propagation, and (2) quinone byproduct formation. The quinone byproduct (i.e., 3,3′,5,5′-tetramethyldiphenoquinone (TMDQ)), when formed, can be incorporated into the polymer backbone by a chain transfer-type reaction, leading to decreased molecular weight in the polymer product. The present inventors have determined that careful selection of the amounts of copper catalyst and diamine ligand can affect the selectivity of the competing reactions. Thus, a poly(phenylene ether), specifically a poly(2,6-dimethyl-1,4-phenylene ether), having a medium molecular weight (i.e., a weight average molecular weight of 10,000 to 40,000 grams per mole, as determined by gel permeation chromatography) can be prepared by a method with specific mole ratios of monomer to copper catalyst and diamine ligand concentrations, which tune the selectivity between polymer propagation and generated quinone byproduct. The medium molecular weight poly(phenylene ether) s described herein can provide unique properties not previously accessible with the corresponding higher or lower molecular weight versions. A significant improvement is therefore provided by the present disclosure.

Accordingly, an aspect of the present disclosure is a medium molecular weight poly(2,6-dimethyl-1,4-phenylene ether). As used herein, the term “medium molecular weight” or “intermediate molecular weight” refers to a poly(phenylene ether) having a weight average molecular greater of 10,000 to 40,000 grams per mole (g/mol), or 15,000 to 35,000 g/mol, or 20,000 to 30,000 g/mol. Weight average molecular weight can be determined using gel permeation chromatography (GPC).

The medium molecular weight poly(phenylene ether) can have an intrinsic viscosity of 0.13 to 0.3 deciliters per gram (dl/g), as determined by Ubbelohde viscometer at 25° C. in chloroform. Within this range, the intrinsic viscosity can be 0.15 to 0.3 dl/g, or 0.18 to 0.3 dl/g, or 0.2 to 0.3 dl/g.

The poly(2,6-dimethyl-1,4-phenylene ether) described herein can also have a narrow molecular weight distribution relative to high molecular weight poly(2,6-dimethyl-1,4-phenylene ether) s and low molecular weight poly(2,6-dimethyl-1,4-phneylene ether)s prepared by conventional methods. For example, the medium molecular weight poly(2,6-dimethyl-1,4-phenylene ether) prepared according to the present disclosure can have a dispersity of 1.5 to 3. Within this range, the dispersity can be 1.8 to 2.5, or 1.9 to 2.4, or 1.9 to 2.3, or 2.0 to 2.3, or 2.0 to 2.25. Dispersity is the ratio of weight average molecular weight to number average molecular weight, each determined by gel permeation chromatography using polystyrene standards. The poly(2,6-dimethyl-1,4-phenylene ether) prepared by the present method can have a unimodal molecular weight distribution, i.e., a molecular weight distribution with one local maximum. In contrast, high molecular weight poly(2,6-dimethyl-1,4-phenylene ether) s prepared by conventional methods can exhibit a bimodal distribution.

The medium molecular weight poly(2,6-dimethyl-1,4-phenylene ether) according to the present disclosure is made by a particular method. The method comprises reacting 2,6-dimethylphenol in the presence of a solvent, oxygen, copper ion, a counter ion, and N,N′-di-tertbutylethylenediamine to form the medium molecular weight poly(2,6-dimethyl-1,4-phenylene ether).

2,6-Dimethylphenol, also known as 2,6-xylenol, is the monomer that is oxidatively polymerized to form the poly(2,6-dimethyl-1,4-phenylene ether). The concentration of 2,6-dimethylphenol in the reaction mixture is expressed as percent solids, which is defined as the weight of 2,6-dimethylphenol divided by the sum of the weights of 2,6-dimethylphenol and solvent. In an aspect, the percent solids is at least 15 weight percent. Within this range, the percent solids can be 15 to 30 weight percent or 15 to 25 weight percent or 20 to 25 weight percent. In an aspect, the first stage of oxidative polymerization reaction, commonly referred to as the exothermic stage, can be initiated in the presence of 1 to 10 weight percent of the total 2,6-dimethylphenol, with the remainder added over time during the same stage.

The solvent can comprise, for example, toluene. In an aspect, toluene can be the only solvent. It will be understood that amine reagents and reaction product water are not considered solvents.

Oxygen, which refers to molecular oxygen (O₂), is an oxidant used for oxidative polymerization of 2,6-dimethylphenol. In the method, oxygen is added to the reaction mixture in a fixed molar ratio relative to added 2,6-dimethylphenol.

Copper ion, which refers to total copper ion, including uncomplexed Cu⁺, complexed Cut, uncomplexed Cu²⁺, complexed Cu²⁺, and combinations thereof, catalyzes oxidative polymerization of 2,6-dimethylphenol. It will be understood that the oxidative nature of the polymerization requires that the copper ion shuttles between the +1 and +2 oxidation states, and that the copper ion can be in either of these oxidation states when initially provided. Suitable sources of copper ion include cuprous chloride, cupric chloride, cuprous bromide, cupric bromide, cuprous sulfate, cupric sulfate, cuprous acetate, and cupric acetate.

The concentration of copper ion in the reaction mixture is expressed as a molar ratio relative to 2,6-dimethylphenol. Specifically, the mole ratio of 2,6-dimethylphenol to copper ion is 900:1 to 1300:1. Within this range, the ratio can be 1000:1 to 1250:1, or 1100:1 to 1200:1.

The counter ion is an ion that complexes with copper. Exemplary counter ions can include halide ions, such as bromide or chloride ions. In an aspect, the counter ion comprises a bromide ion. It will be understood that “bromide ion” refers to total bromide ion (including free and complexed forms). Sources of bromide ion include hydrobromic acid, cuprous bromide, cupric bromide, alkali metal bromides (including sodium bromide and potassium bromide), alkaline earth metal bromides, and combinations thereof. The concentration of counter ion in the reaction mixture is expressed as a mole ratio relative to copper ion. Typically, the mole ratio of counter ion (e.g., bromide ion) to copper ion can be 1:1 to 20:1. Other ratios may also be useful.

N,N′-Di-tert-butylethylenediamine forms a complex with copper ion that is an active catalyst for oxidative polymerization of 2,6-dimethylphenol. It will be understood that the term “N,N′-di-tert-butylethylenediamine” refers to total N,N′-di-tert-butylethylenediamine (including free and complexed forms).

The concentration of N,N′-di-tert-butylethylenediamine can be expressed as a weight percent relative to the weight of 2,6-dimethylphenol. Specifically, the N,N′-di-tertbutylethylenediamine can be present in an amount of 0.47 to 0.6 weight percent, or 0.47 to 0.55 weight percent, each based on the weight of 2,6-dimethylphenol.

In addition to the N,N′-di-tert-butylethylenediamine, the reaction mixture can contain a secondary monoamine (e.g., di-n-butylamine), a tertiary monoamine (e.g., dimethyl-N-butylamine), or both. For example, the oxidative reaction of the 2,6-dimethylphenol can be conducted in the presence of di-n-butylamine at 0.5 to 5 weight percent or 0.5 to 2 weight percent, or 0.5 to 1.5 weight percent, and dimethyl-N-butylamine at 0.5 to 6 weight percent or 1 to 5 weight percent, or 2 to 5 weight percent, or 3 to 4 weight percent, each based on the total weight of 2,6-dimethylphenol.

The oxidative reaction of the 2,6-dimethylphenol can be conducted in the presence of a phase transfer agent. An exemplary chain transfer agent is N,N,N′N′-didecyldimethyl ammonium chloride.

The oxidative polymerization of 2,6-dimethylphenol can be separated into two stages. The first or “exothermic” stage, mentioned above, occurs as the reaction is initiated by introduction of oxygen to a solution containing a small amount of the 2,6-dimethylphenol and continues through the addition of the remaining 2,6-dimethylphenol. As suggested by the name, the exothermic stage is characterized by the release of beat, and the reaction mixture is typically cooled to maintain a temperature of 15 to 35° C. Within this range, the temperature can be 20 to 30° C., or 20 to 25° C. The reaction conditions described above are for the exothermic stage of the polymerization.

During the second or “build” stage of polymerization, the reaction mixture is typically maintained at a temperature of 20 to 80° C. Within this range, the temperature can be 30 to 70° C., specifically 35 to 55° C. In an aspect, reagent concentrations other than oxygen are not actively adjusted between the exothermic phase and the build phase, and during the build phase. That is, no action is taken to add to or reduce the concentrations of 2,6-dimethylphenol, copper ion, N,N′-di-tert-butylethylenediamine, di-N-butylamine, or dimethyl-N-butylamine. During the build stage, the oxygen flow rate is typically reduced to 15 to 35 percent of its flow rate during the exothermic stage.

The build stage and the oxidative polymerization reaction as a whole are terminated when a chelating agent is added to the reaction mixture to chelate the copper ion and thereby destroy the active catalyst. Copper chelation is a well-known step in poly(phenylene ether) synthesis, and suitable chelating agents are known. These include ethylenediaminetetraacetic acid and its alkali metal salts, and nitrilotriacetic acid and its alkali metal salts. An exemplary chelating agent is trisodium nitrilotriacetate. The chelating agent can be added in solid form, or as a solution (e.g., an aqueous solution). Addition of the chelating agent terminates the build stage and initiates the equilibration stage. Due in part to the two-phase nature of the reaction mixture (organic and aqueous), complexation of copper ion by the chelating agent is not instantaneous and requires significant time at elevated temperature. For example, the equilibration stage may be conducted at a temperature of 45 to 75° C. for a time of 10 to 200 minutes. Within these ranges, the temperature can be 50 to 70° C., and the time can be 20 to 45 minutes. An undesirable side-effect of the equilibration stage can be that over time the poly(2,6-dimethyl-1,4-phenylene ether) intrinsic viscosity decreases, and the dispersity increases. There can therefore be a trade-off between reducing the residual copper content of the isolated poly(2,6-dimethyl-1,4-phenylene ether), and adversely affecting its molecular weight characteristics. Methods of reducing adverse effects of the equilibration step on molecular weight characteristics are known. See, for example, U.S. Pat. No. 8,025,158 to Delsman et al.

The method can optionally further comprise terminating the reaction when a predetermined intrinsic viscosity or predetermined molecular weight is reached. For example, and end point monitoring device can be employed, which is capable of in situ monitoring of the solution viscosity, enabling calculation of the poly(phenylene ether) intrinsic viscosity.

In a specific aspect, the 2,6-dimethyl phenol can be present at a solids content of 15 to 30 weight percent, based on the total weight of 2,6-dimethylphenol and solvent; the N,N′-di-tertbutylethylenediamine can be present in an amount of 0.47 to 0.55 weight percent based on the weight of 2,6-dimethylphenol; the copper ion can be present in a molar ratio of 2,6-dimethylphenol to copper ion of 1100:1 to 1200:1.

The medium molecular weight poly(2,6-dimethyl-1,4-phenylene ether) provided by the method according to the present disclosure can be incorporated into a thermoplastic composition. Accordingly, a thermoplastic composition comprising the medium molecular weight poly(2,6-dimethyl-1,4-phenylene ether) represents another aspect of the present disclosure. The thermoplastic composition comprises the medium molecular weight poly(2,6-dimethyl-1,4-phenylene ether) and at least one additional component.

In an aspect, the thermoplastic composition can comprise the medium molecular weight poly(2,6-dimethyl-1,4-phenylene ether) and at least one polymer that is different from the medium molecular weight poly(2,6-dimethyl-1,4-phenylene ether). The additional polymer can be different in terms of chemical composition, molecular weight, or both. For example, the thermoplastic composition can comprise the medium molecular weight poly(2,6-dimethyl-1,4-phenylene ether) and a polyphenylene ether having a high molecular weight (i.e., a weight average molecular weight of greater than 40,000 g/mol) or a low molecular weight (i.e., a weight average molecular weight of less than 10,000 g/mol).

In an aspect, the thermoplastic composition can comprise a thermoplastic polymer different from the medium molecular weight poly(2,6-dimethyl-1,4-phenylene ether), wherein the thermoplastic polymer can comprise, for example, polyacetals (e.g., polyoxyethylene and polyoxymethylene), poly(C₁₋₆ alkyl) acrylates, polyacrylamides, polyamides, (e.g., aliphatic polyamides, polyphthalamides, and polyaramides), polyamideimides, polyanhydrides, polyarylates, polyarylene sulfides (e.g., polyphenylene sulfides), polyarylene sulfones (e.g., polyphenylene sulfones), polybenzothiazoles, polybenzoxazoles, polycarbonates (including polycarbonate copolymers such as polycarbonate-siloxanes, polycarbonate-esters, and polycarbonate-ester-siloxanes), polyesters (e.g., polyethylene terephthalates, polybutylene terephthalates, polyarylates, and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly(C₁₋₆ alkyl) methacrylates, polymethacrylamides, polynorbornenes (including copolymers containing norbornenyl units), polyolefins (e.g., polyethylenes, polypropylenes, polytetrafluoroethylenes, and their copolymers, for example ethylene-alpha-olefin copolymers), polyoxadiazoles, polyoxymethylenes, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl ketones, polyvinyl thioethers, polyvinylidene fluorides, or a combination thereof.

In an aspect, the thermoplastic polymer can comprise a polycarbonate, a polyetherimide, a polyimide, a polysulfone, a polyethersulfone, a polyphenylene sulfone, a polyarylene ether, a polyetherether ketone, a polyamide, or a combination thereof. In an aspect, the thermoplastic polymer can comprise a polyolefin or a polystyrene copolymer such as ABS, which can be especially useful in a wide variety of articles, have good processability, and are recyclable.

When present, the polymer different from the medium molecular weight poly(2,6-dimethyl-1,4-phenylene ether) can be included in the composition in an amount of 1 to 99 weight percent, or 5:95 to 95:5, or 10 to 90 weight percent, or 20 to 80 weight percent, or 30 to 70 weight percent, or 40 to 60 weight percent, each based on the total weight of the composition.

The thermoplastic composition comprising the medium molecular weight poly(2,6-dimethyl-1,4-phenylene ether) can optionally comprise an additive composition. The additive composition comprises one or more additives selected to achieve a desired property, with the proviso that the additive(s) are also selected so as to not significantly adversely affect a desired property of the thermoplastic composition. The additive composition or individual additives can be mixed at a suitable time during the mixing of the components for forming the composition. The additive can be soluble or non-soluble in polyphenylene ether. The additive composition can include an impact modifier, flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, flame retardant, anti-drip agent (e.g., a PTFE-encapsulated styrene-acrylonitrile copolymer (TSAN)), or a combination thereof. For example, a combination of a beat stabilizer, mold release agent, and ultraviolet light stabilizer can be used. In general, the additives are used in the amounts generally known to be effective. For example, the total amount of the additive composition (other than any impact modifier, filler, or reinforcing agent) can be 0.001 to 10.0 weight percent, or 0.01 to 5 weight percent, each based on the total weight of the composition.

The medium molecular weight poly(2,6-dimethyl-1,4-phenylene ether) and the composition comprising the medium molecular weight poly(2,6-dimethyl-1,4-phenylene ether) are useful for forming various articles. Suitable methods of forming such articles include single layer and multilayer sheet extrusion, injection molding, blow molding, film extrusion, profile extrusion, pultrusion, compression molding, thermoforming, pressure forming, hydroforming, vacuum forming, and the like. Combinations of the foregoing article fabrication methods can be used. When an article is prepared by molding, the poly(2,6-dimethyl-1,4-phenylene ether) can be blended with another polymer to form a molding composition. Polymers suitable for blending with the poly(2,6-dimethyl-1,4-phenylene ether) can include those described above in the context of the thermoplastic composition, for example polystyrenes, unhydrogenated and hydrogenated block copolymers of styrene and butadiene, unhydrogenated and hydrogenated block copolymers of styrene and isoprene, polyamides, polyesters, polyolefins, and combinations thereof. The poly(2,6-dimethyl-1,4-phenylene ether) and the other polymer can be blended in a weight ratio of, for example, 5:95 to 95:5, or 10:90 to 90:10, or 20:80 to 80:20. When present, an additive composition or individual additives can be mixed at a suitable time during the mixing of the components for forming the composition and subsequent articles.

This disclosure is further illustrated by the following examples, which are non-limiting.

### Examples

Materials used in the following examples are described in Table 1.

TABLE 1

| Material | Chemical Description |
|---|---|
| DMP | 2,6-Xylenol, CAS Reg. No. 576-26-1 |
| Cu₂O | Cuprous oxide, CAS Reg. No. 1317-39-1 |
| HBr | Hydrobromic acid, CAS Reg. No. 10035-10-6 |
| DBEDA | N,N′-Di-tert-butylethylenediamine, CAS Reg. No. 4062-60-6 |
| DBA | Di-n-butylamine, CAS Reg. No. 111-92-2 |
| DMBA | N,N-Dimethylbutylamine, CAS Reg. No. 927-62-8 |
| DMAC | N,N,N′N′- Didecyldimethyl ammonium chloride, |
| | CAS Reg. No. 7173-51-5, obtained as MAQUAT ™ |
| NTA | Nitrilotriacetic acid trisodium salt, CAS Reg. No. 5064-31-3 |
| Toluene | Toluene, CAS Reg. No. 108-88-3 |

Oxidative coupling polymerization reactions were conducted according to the following general procedure. A 60-gallon reactor was used to perform the oxidative coupling polymerization reactions. A monomer mixture was prepared by blending specific amounts of DMP and toluene (shown below in Table 2) at 60° C. in a vessel and stirring this mixture until DMP was dissolved. Initially, 8.9 kilograms of monomer solution in toluene was added to the reactor after charging additional amount of toluene (96 kilograms (kg)) to the reactor under nitrogen atmosphere. Then, DBA, DMBA, a previously prepared mixture of DBEDA, DMAC and toluene, and a previously prepared mixture of Cu₂O and HBr were added to the reactor, followed by introducing oxygen to the reaction mixture at time zero at 18° C. The remaining monomer solution was then introduced to the reactor over 45 minutes. Oxygen flow rate was adjusted to a maximum of 120 standard cubic feet per hour (SCFH) for the first 90-110 minutes of the reaction to ensure that the headspace oxygen concentration is kept below 13% for safety reasons. Reaction temperature was also adjusted to a maximum of 32° C. during first 75 minutes of the reaction. After this period of time, oxygen flow was decreased to keep headspace oxygen concentration below 20% concurrently with ramping the reaction temperature from 32° C. to attain 49° C. at 90 minutes of the reaction. An end point monitor (EPM) device capable of conducting in situ viscosity measurements was used to determine the reaction time. Oxygen flow to the reaction was stopped to terminate the reaction when the predetermined intrinsic viscosity (IV) set point in EPM was reached, which is defined as “end of reaction”. After the end of reaction, the reaction mixture was heated to 60° C. before transferring the reaction mixture to another vessel for copper removal. Copper was removed from the reaction mixture by adding a chelating agent, NTA (aq), to the reaction mixture and stirring final mixture for 2 hours at 60° C. NTA forms a water-soluble complex with copper present in the organic (toluene) phase of the final mixture and transfers it to the aqueous phase of the reaction mixture. The organic phase and aqueous phase were separated by decantation to isolate polyphenylene ether polymer solution in toluene.

The polymers were further isolated as solids by precipitating the polymer solution in toluene into methanol with a 1:4 (wt:wt) ratio in a 44-gallon vessel at 40° C. The obtained slurry was then transferred to a filter dryer where the final powder was isolated by filtering the slurry, washing the resulting wet cake with methanol, and drying.

Samples were obtained throughout the process which were then analyzed by different test methods to determine and monitor final polymer properties such as intrinsic viscosity (IV), number average molecular weight (Mₙ) and weight average molecular weight (M_{w}).

Intrinsic viscosity of the polyphenylene ether was measured by an Ubbelohde capillary type viscometer. Different concentrations of polymers were prepared in chloroform and measurements were done at 25° C. in a thermostated water bath. The flow time data was used to calculate the intrinsic viscosity by extrapolating the reduced viscosity to zero concentration.

Mₙ and M_{w} were characterized using gel permeation chromatography (GPC). The GPC system included an Agilent 1260 Infinity II single channel pump, an Agilent 1260 Infinity II autosampler, an Agilent 1260 Infinity II temperature-controlled column compartment, and an Agilent 1260 Infinity II variable wavelength detector (VWD). The software used to control the instrument and collect the signal was Agilent GPC/SEC Software Version A.02.01. Samples were prepared at approximately 1 milligram per milliliter (mg/ml) concentration and the injection volume was 50 microliters (μL). The VWD was operated in dual wavelength collection mode at 254 and 280 nanometers (nm). The column set consisted of two Agilent PolyPore 7.5×300 mm columns in series maintained at 40° C. The flow rate was set to 1 milliliter per minute and the mobile phase was chloroform.

Results are summarized in Table 2.

TABLE 2

| | Units | E1 | E2 | E3 | E4* | E5* |
|---|---|---|---|---|---|---|
| DMP | kg | 45.53 | 45.53 | 45.53 | 45.53 | 63.77 |
| Toluene | kg | 152.2 | 152.2 | 152.2 | 152.2 | 135.3 |
| DBA | g | 454.7 | 454.7 | 454.7 | 454.7 | 477.7 |
| DBEDA | g | 224.2 | 224.2 | 224.2 | 314.8 | 280.2 |
| DMBA | g | 1522.3 | 1522.3 | 1522.3 | 1522.3 | 1353.5 |
| HBr, 48% solution | g | 141.5 | 141.5 | 141.5 | 199.9 | 169.9 |
| Cu₂O | g | 23.3 | 23.3 | 23.3 | 32.9 | 27.9 |
| Solid content in the reactor¹ | wt % | 23.3 | 23.3 | 23.3 | 23.3 | 32.0 |
| DBA² | wt % | 1.0 | 1.0 | 1.0 | 1.0 | 0.75 |
| DBEDA² | wt % | 0.49 | 0.49 | 0.49 | 0.69 | 0.44 |
| DMBA² | wt % | 3.3 | 3.3 | 3.3 | 3.3 | 2.1 |
| Cu₂O² | wt % | 0.05 | 0.05 | 0.05 | 0.07 | 0.04 |
| Cu ion | moles | 0.326 | 0.326 | 0.326 | 0.46 | 0.39 |
| DMP | moles | 372.677 | 372.677 | 372.677 | 372.677 | 521.977 |
| DMP:Cu ion | mol:mol | 1,143.18 | 1,143.18 | 1,143.18 | 810.17 | 1,338.4 |
| EPM set point | dl/g | 0.25 | 0.20 | 0.17 | N/A | N/A |
| Final IV | dl/g | 0.288 | 0.281 | 0.259 | 0.417 | 0.129 |
| Mₙ | g/mol | 12,420 | 12,250 | 10,650 | 14,210 | 2,800 |
| M_{w} | g/mol | 27,320 | 26,950 | 23,250 | 50,640 | 6,750 |

¹weight percent of DMP in toluene;
²weight percent based on weight of DMP;
*indicates a comparative example

As shown in Table 2, five runs using different reaction conditions were compared. The runs according to E1, E2 and E3 were performed at same reaction conditions but stopped based on different EPM set points. The runs according to E1, E2, and E3 had lower DBEDA feeds and lower copper catalyst loadings compared to B4. The run according to E5 had higher solids content but lower DBA, DBEDA, DMBA and copper catalyst loadings compared to the reaction runs according to E1, E2, E3, and E4.

The polymer characterization shown in Table 2 indicates that poly(phenylene ether) s with intermediate molecular weights and intrinsic viscosities can be obtained using the reaction conditions exemplified by the runs according to E1-E3. E4 resulted in a poly(phenylene ether) having high molecular weight and intrinsic viscosity. In contrast, B5 provided a poly(phenylene ether) having a low molecular weight and intrinsic viscosity.

This disclosure further encompasses the following aspects.

Aspect 1: A medium molecular weight poly(2,6-dimethyl-1,4-phenylene ether) having a weight average molecular weight of 10,000 to 40,000 grams per mole, determined using gel permeation chromatography; and an intrinsic viscosity of 0.13 to 0.3 deciliters per gram, as determined by Ubbelohde viscometer at 25° C. in chloroform; wherein the medium molecular weight polyphenylene ether is made by method comprising: reacting 2,6-dimethylphenol in the presence of a solvent, oxygen, copper ion, a counter ion, and N,N′-di-tertbutylethylenediamine to form the medium molecular weight poly(2,6-dimethyl-1,4-phenylene ether); wherein N,N′-di-tertbutylethylenediamine is present in an amount of 0.47 to 0.6 weight percent based on the weight of 2,6-dimethylphenol; and wherein the copper ion is present in a molar ratio of 2,6-dimethylphenol to copper ion of 900:1 to 1300:1.

Aspect 2: The medium molecular weight poly(2,6-dimethyl-1,4-phenylene ether) of aspect 1, having a weight average molecular weight of 15,000 to 35,000 grams per mole, determined using gel permeation chromatography, and an intrinsic viscosity of 0.18 to 0.3 deciliters per gram, as determined by Ubbelohde viscometer at 25° C. in chloroform.

Aspect 3: The medium molecular weight poly(2,6-dimethyl-1,4-phenylene ether) of aspect 1 or 2, wherein the reacting 2,6-dimethylphenol comprises reacting a total of at least 15 weight percent, or 15 to 30 weight percent, or 15 to 25 weight percent, or 20 to 25 weight percent 2,6-dimethylphenol, based on the total weight of 2,6-dimethylphenol and solvent.

Aspect 4: The medium molecular weight poly(2,6-dimethyl-1,4-phenylene ether) of any of aspects 1 to 3, wherein the N,N′-di-tertbutylethylenediamine is present in an amount of 0.47 to 0.55 weight percent based on the weight of 2,6-dimethylphenol.

Aspect 5: A method for the manufacture of a medium molecular weight poly(2,6-dimethyl-1,4-phenylene ether), the method comprising: reacting 2,6-dimethylphenol in the presence of a solvent, oxygen, copper ion, a counter ion, and N,N′-di-tertbutylethylenediamine to form the poly(2,6-dimethyl-1,4-phenylene ether); wherein N,N′-di-tertbutylethylenediamine is present in an amount of 0.47 to 0.6 weight percent based on the weight of 2,6-dimethylphenol; wherein the copper ion is present in a molar ratio of 2,6-dimethylphenol to copper ion of 900:1 to 1300:1; wherein the poly(2,6-dimethyl-1,4-phenylene ether) has a weight average molecular weight of 10,000 to 40,000 grams per mole, determined using gel permeation chromatography; and wherein the poly(2,6-dimethyl-1,4-phenylene ether) has an intrinsic viscosity of 0.13 to 0.3 deciliters per gram, as determined by Ubbelohde viscometer at 25° C. in chloroform.

Aspect 6: The method of aspect 5, wherein the reacting 2,6-dimethylphenol comprises reacting a total of at least 15 weight percent, or 15 to 30 weight percent, or 15 to 25 weight percent, or 20 to 25 weight percent 2,6-dimethylphenol, based on the total weight of 2,6-dimethylphenol and solvent.

Aspect 7: The method of aspects 5 or 6, wherein the N,N′-di-tertbutyletbylenediamine is present in an amount of 0.47 to 0.55 weight percent based on the weight of 2,6-dimethylphenol.

Aspect 8: The method of any of aspects 5 to 7, wherein the copper ion is present in a molar ratio of 2,6-dimethylphenol to copper ion of 1100:1 to 1200:1.

Aspect 9: The method of any of aspects 5 to 8, further comprising terminating the reaction when a predetermined intrinsic viscosity or predetermined molecular weight is reached.

Aspect 10: The method of any of aspects 5 to 9, wherein the reacting 2,6-dimethylphenol comprises reacting a total of 15 to 30 weight percent, based on the total weight of 2,6-dimethylphenol and solvent; the N,N′-di-tertbutylethylenediamine is present in an amount of 0.47 to 0.55 weight percent based on the weight of 2,6-dimethylphenol; the copper ion is present in a molar ratio of 2,6-dimethylphenol to copper ion of 1100:1 to 1200:1; the polyphenylene ether has a weight average molecular weight of 15,000 to 35,000 grams per mole; and the polyphenylene ether has an intrinsic viscosity of has an intrinsic viscosity of 0.18 to 0.3 deciliters per gram.

Aspect 11: A poly(2,6-dimethyl-1,4-phenylene ether) made by the method of any of aspects 5 to 10.

Aspect 12: A thermoplastic composition comprising the poly(2,6-dimethyl-1,4-phenylene ether) of any of aspects 1 to 4 or 11 or the poly(2,6-dimethyl-1,4-phenylene ether) made by the method of any of aspects 5 to 10.

Aspect 13: The thermoplastic composition of aspect 12, further comprising a polymer different from the poly(2,6-dimethyl-1,4-phenylene ether).

Aspect 14: The thermoplastic composition of aspects 12 or 13, further comprising an additive.

Aspect 15: An article comprising: the poly(2,6-dimethyl-1,4-phenylene ether) of any of aspects 1 to 4 or 11; or the poly(2,6-dimethyl-1,4-phenylene ether) made by the method of any of aspects 5 to 10; or the thermoplastic composition of any of aspects 12 to 14.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O) 2-alkyl), a C₆₋₁₂ aryl sulfonyl (—S(═O) 2-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A medium molecular weight poly(2,6-dimethyl-1,4-phenylene ether) having a weight average molecular weight of 10,000 to 40,000 grams per mole, determined using gel permeation chromatography; and an intrinsic viscosity of 0.13 to 0.3 deciliters per gram, as determined by Ubbelohde viscometer at 25° C. in chloroform; wherein the medium molecular weight polyphenylene ether is made by method comprising:
reacting 2,6-dimethylphenol in the presence of a solvent, oxygen, copper ion, a counter ion, and N,N′-di-tertbutylethylenediamine to form the medium molecular weight poly(2,6-dimethyl-1,4-phenylene ether);
wherein N,N′-di-tertbutylethylenediamine is present in an amount of 0.47 to 0.6 weight percent based on the weight of 2,6-dimethylphenol; and
wherein the copper ion is present in a molar ratio of 2,6-dimethylphenol to copper ion of 900:1 to 1300:1.

2. The medium molecular weight poly(2,6-dimethyl-1,4-phenylene ether) of claim 1, having a weight average molecular weight of 15,000 to 35,000 grams per mole, determined using gel permeation chromatography, and an intrinsic viscosity of 0.18 to 0.3 deciliters per gram, as determined by Ubbelohde viscometer at 25° C. in chloroform.

3. The medium molecular weight poly(2,6-dimethyl-1,4-phenylene ether) of claim 1, wherein the reacting 2,6-dimethylphenol comprises reacting a total of at least 15 weight percent 2,6-dimethylphenol, based on the total weight of 2,6-dimethylphenol and solvent.

4. The medium molecular weight poly(2,6-dimethyl-1,4-phenylene ether) of claim 1, wherein the N,N′-di-tertbutylethylenediamine is present in an amount of 0.47 to 0.55 weight percent based on the weight of 2,6-dimethylphenol.

5. A method for the manufacture of a medium molecular weight poly(2,6-dimethyl-1,4-phenylene ether), the method comprising:
reacting 2,6-dimethylphenol in the presence of a solvent, oxygen, copper ion, a counter ion, and N,N′-di-tertbutylethylenediamine to form the poly(2,6-dimethyl-1,4-phenylene ether);
wherein N,N′-di-tertbutylethylenediamine is present in an amount of 0.47 to 0.6 weight percent based on the weight of 2,6-dimethylphenol;
wherein the copper ion is present in a molar ratio of 2,6-dimethylphenol to copper ion of 900:1 to 1300:1;
wherein the poly(2,6-dimethyl-1,4-phenylene ether) has a weight average molecular weight of 10,000 to 40,000 grams per mole, determined using gel permeation chromatography; and
wherein the poly(2,6-dimethyl-1,4-phenylene ether) has an intrinsic viscosity of 0.13 to 0.3 deciliters per gram, as determined by Ubbelohde viscometer at 25° C. in chloroform.

6. The method of claim 5, wherein the reacting 2,6-dimethylphenol comprises reacting a total of at least 15 weight percent 2,6-dimethylphenol, based on the total weight of 2,6-dimethylphenol and solvent.

7. The method of claim 5, wherein the N,N′-di-tertbutylethylenediamine is present in an amount of 0.47 to 0.55 weight percent based on the weight of 2,6-dimethylphenol.

8. The method of claim 1, wherein the copper ion is present in a molar ratio of 2,6-dimethylphenol to copper ion of 1100:1 to 1200:1.

9. The method of claim 1, further comprising terminating the reaction when a predetermined intrinsic viscosity or predetermined molecular weight is reached.

10. The method of claim 5, wherein
the reacting 2,6-dimethylphenol comprises reacting a total of 15 to 30 weight percent, based on the total weight of 2,6-dimethylphenol and solvent;
the N,N′-di-tertbutylethylenediamine is present in an amount of 0.47 to 0.55 weight percent based on the weight of 2,6-dimethylphenol;
the copper ion is present in a molar ratio of 2,6-dimethylphenol to copper ion of 1100:1 to 1200:1;
the polyphenylene ether has a weight average molecular weight of 15,000 to 35,000 grams per mole; and
the polyphenylene ether has an intrinsic viscosity of has an intrinsic viscosity of 0.18 to 0.3 deciliters per gram.

11. A poly(2,6-dimethyl-1,4-phenylene ether) made by the method of claim 5.

12. A thermoplastic composition comprising the poly(2,6-dimethyl-1,4-phenylene ether) of claim 1.

13. The thermoplastic composition of claim 12, further comprising a polymer different from the poly(2,6-dimethyl-1,4-phenylene ether).

14. The thermoplastic composition of claim 12, further comprising an additive composition.

15. An article comprising:
the thermoplastic composition of claim 12.

16. The medium molecular weight poly(2,6-dimethyl-1,4-phenylene ether) of claim 1, wherein the reacting 2,6-dimethylphenol comprises reacting a total of 15 to 30 weight percent 2,6-dimethylphenol, based on the total weight of 2,6-dimethylphenol and solvent.

17. The method of claim 5, wherein the reacting 2,6-dimethylphenol comprises reacting a total of 15 to 25 weight percent 2,6-dimethylphenol, based on the total weight of 2,6-dimethylphenol and solvent.

18. An article comprising: a poly(2,6-dimethyl-1,4-phenylene ether) made by the method of claim 5.
